(19) United States
(12) Patent Application Publication
(10) Pub. No.: US 2016/0040405 A1
(43) Pub. Date: Feb. 11, 2016

(54) KITCHEN FITTING AND OPERATING METHOD

(71) Applicant: WWB BV, GG Ter Aar (NL)

(72) Inventors: Henk TALSMA, Berlin (DE); Rob LANGENDIJK, Berlin (DE)

(21) Appl. No.: 14/776,095

(22) PCT Filed: Mar. 12, 2014
(86) PCT No.: PCT/EP2014/054892

§ 371 Date: Sep. 14, 2015

(30) Foreign Application Priority Data
Mar. 12, 2013 (DE) 20 2013 101 071.5

(51) Int. Cl. E03C 1/05; G05D 7/06; E03C 1/04

(52) U.S. Cl. CPC E03C 1/057; E03C 1/0403; G05D 7/0635; E03C 1/0404; E03C 2001/026

(57) ABSTRACT

A kitchen fitting (1), a method for operating a kitchen fitting and a kitchen device are provided. The kitchen fitting (1) has an outlet fitting (2), a fluid supply (3) and an operating unit (5). The fluid supply (3) is intended for one or more fluids. The operating unit (5) has a controller (6) and one or more operating elements (7 to 11) connected thereto. One operating element (7) is designed as a non-contact on/off switch (7) for a fluid flow (47). The non-contact on/off switch (7) switches on the fluid flow (47) when actuated and switches off the fluid flow (47) when actuated again. The non-contact on/off switch (7) can preferably be designed as a pulse switch.

### CROSS REFERENCE TO RELATED APPLICATIONS

This application is a United States National Phase Application of International Application PCT/EP2014/054892 filed Mar. 12, 2014 and claims the benefit of priority under 35 U.S.C. §119 of German Application 20 2013 101 071.5 filed Mar. 12, 2013 the entire contents of which are incorporated herein by reference.

### FIELD OF THE INVENTION

The present invention pertains to a kitchen fitting with an outlet fitting and with a fluid supply for one or more fluids and with an operating unit, which has a control device and one or more operating elements connected thereto and to an operating method for operating such a kitchen fitting.

### BACKGROUND OF THE INVENTION

A multifunction fitting is known from DE 10 2006 062 182 A1. It has an outlet fitting and a fluid supply for a plurality of fluids, whose state may possibly be different. The multifunction fitting has, furthermore, an operating unit with a control device and with one or more operating elements connected thereto. The operating element for water is designed as a permanent switch, which continuously detects and signals the existence and motion of a hand under an outlet opening, the control device allowing the water to flow while the switch signal is present and switches it off independently after a preset time if the switch signal becomes absent.

### SUMMARY OF THE INVENTION

An object of the present invention is to provide an improved multifunction fitting and an operating method, which is suitable for use in kitchens.

The kitchen fitting and operating method being claimed have the advantage that they are optimally suitable for use in kitchens thanks to the contactless on/off switch. The duration during which the fluid or the fluid flow, especially the flow of water, is released can be controlled by the user as desired by specific actuation and especially by actuating pulses. The contactless operating element is switched on at the time of an actuation and switched off again at the time of a repeated actuation. The actuation may be carried out manually by a motion of a body part, especially a hand, into the range of action of the contactless operating element.

The contactless operating element is advantageously designed as a contactless on/off switch, especially as a pulse switch. Operating pulses can be triggered by the motion of a body part, especially a hand

The fluid flow may remain switched on after it has been switched on independently from the time during which a body part is present in the range of action of the contactless on/off switch. The on time of the fluid flow does not depend, contrary to the state of the art, on the time during which the body part is present in the range of action of the contactless on/off switch.

After a single-time actuation, the operator can remove his hands from the range of action of the contactless on/off switch, and the switched-on fluid flow, preferably a flow of water, continues to be present. The operator can then perform other activities in the kitchen while the fluid flow is flowing. He can select the outflow time of the fluid flow as desired and ends it by repeatedly actuating the on/off switch. This on/off switching function and the arbitrarily selectable outflow time make it possible to fill vessels, such as pots, glasses or kitchen sinks in a specific manner, without a hand having to be continuously held for this in the range of action of the operating element and especially under an outflow opening. Only hands moving continuously, but not the above-mentioned vessels are recognized as a triggering event by the prior-art operating elements, so that the kitchen fitting being claimed is better suited for use in kitchens than the prior-art multifunction fitting.

A contactless on/off switch has, furthermore, the advantage that its function can be recognized and used by the operator more easily. In particular, the on/off switching function can be understood and used more simply and better. The contactless on/off switch being claimed has a preferably upwardly directed range of action, which offers advantages in terms of ergonomics and intuitive recognition. The on/off switch is well-suited and can be used equally well by right-handed and left-handed persons. Special advantages arise in terms of ergonomics and operability in case the on/off switch is arranged on a fitting head at the free upper end of a fitting pipe and especially in case of arrangement on the top side of such a fitting head.

The on/off switch is designed as a contactless sensor, preferably as an optical sensor. This sensor is preferably designed as a reflected light scanner in the invisible range of light, especially in the infrared range. Interference problems arise in case of the use of such an optical sensor with a preferably upwardly directed range of action due to the incidence of outside light, reflections and other light phenomena usually occurring in the area of a kitchen. A covering that reduces the incidence of outside light is advantageous for eliminating these interference problems. The optical sensor being claimed can accurately distinguish the sensor and signal light from outside light, as a result of which the quality of detection and switching is especially high.

The contactless on/off switch may interact with a display unit, which provides easy-to-understand and intuitively understandable user information. In particular, the on/off switching function can be symbolized and made understandable by a common symbol in an especially simple manner. The display unit in question may signal, in addition, the position and possibly the range of action of the on/off switch to the user, which likewise makes simple and intuitive operation possible and relieves the user of a complicated stage of operating instructions and of trials to test the function.

The contactless on/off switch may be combined with one or more contactless operating elements or possibly with additional operating elements that can be actuated by touch in a sensor unit, which may be complemented with a corresponding display unit. Additional functions, such as temperature selection, selection of other fluids or the like, can be switched and controlled by means of this. The kitchen fitting may be multifunctional and also release other fluids, e.g., dishwashing detergent, disinfectant, skin care lotion or the like, besides water, in a controlled manner.

The kitchen fitting may have, furthermore, a flow rate setter, with which the flow rate or the intensity of the fluid flow switched by the on/off switch can be controlled. The flow rate setter may have a manual setter, e.g., a knob, which can be operated by touch. The function of such a manual setter is known to the operator from conventional mechanical kitchen fittings and is easy to understand. The combination of operating elements that can be actuated in a contactless manner, especially sensors, and a manual setter is a highly favorable ergonomic solution for the area of kitchens.

The kitchen fitting being claimed offers special advantages for the area of kitchens. The dispensing of a plurality of fluids at the outlet fitting in connection with a corresponding fluid supply is ergonomically especially favorable and eliminates the need for the hitherto complicated handling of various containers for the additional fluids. Hygiene is improved as well. The contactless operating elements can be actuated especially rapidly and simply, and they are also less subject to the risk of contamination thanks to the contactless operation. In particular, the user does not have to wash his hands before an actuation. Actuation is possible, moreover, with other body parts, especially the elbow or the like.

The most important functions of the kitchen fitting, such as the switching of a fluid, especially water, on and off, and the possible additional functions, such as temperature regulation and the selection of additional fluids, can be triggered and controlled at a central location. This markedly simplifies the handling, and arrangement of the sensor unit on the fitting hand also offers special advantages for reachability and intuitive operation. Due to its different types of information, the display unit supports easy operability and can, in addition, also send acknowledgement signals for the successful operation of an operating element. Illumination and various lighting elements are especially advantageous for this. In addition, such a feature makes the kitchen fitting attractive in terms of its appearance and usability.

It is, furthermore, advantageous for use in kitchens if the armature pipe is movable, especially pivotable. A pull-out section with a movable flexible tube section may possibly be present. A grip facilitates the handling and motion of the fitting pipe.

The fluid supply being claimed offers the advantage of making accommodation possible in a compact and protected manner for one or more replaceable fluid containers and for simple and reliable handling of such additional fluids. Special advantages arise in terms of hygiene as well.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a kitchen device with a kitchen fitting;

FIG. 2 is a perspective front view of the kitchen fitting according to FIG. 1;

FIG. 3 is an enlarged front view of the fitting head of the kitchen fitting from FIGS. 1 and 2;

FIG. 4 is a side view of the kitchen device according to FIG. 1;

FIG. 5 is a perspective view showing a variant of the kitchen fitting; and

FIG. 6 is a side view showing a variant of the kitchen fitting.

### DESCRIPTION OF THE PREFERRED EMBODIMENTS

The present invention pertains to a kitchen fitting (1) and a kitchen device (4) with such a kitchen fitting (1). The present invention pertains, furthermore, to an operating method for a kitchen fitting (1).

The kitchen fitting (1) is especially suitable for use in kitchens. On the other hand, it also forms a multifunction fitting, which can be used in other areas of use. This also applies to the operating method.

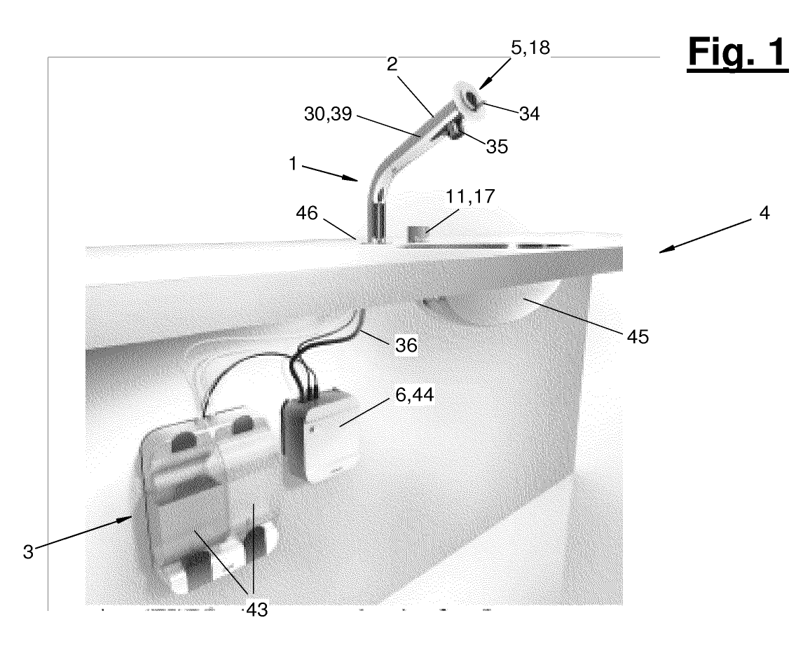

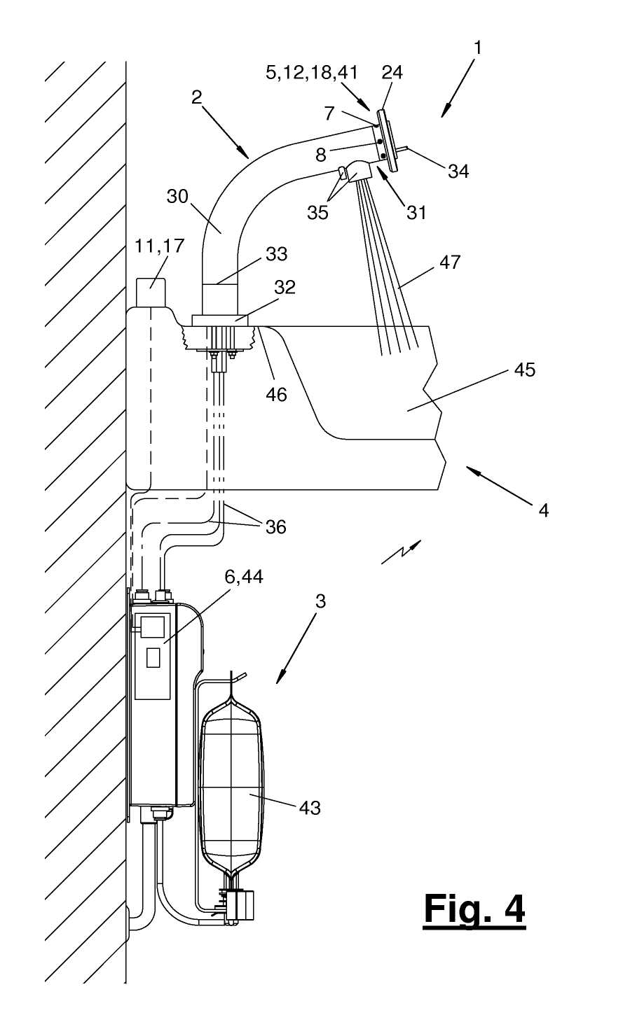

FIGS. 1 and 4 show such a kitchen device (4) with a kitchen fitting (1). The kitchen device (4) has a kitchen sink (45), e.g., a dishwashing sink, which is installed in a corresponding mount, especially in a kitchen cabinet or the like. The kitchen fitting (1) has an outlet fitting (2) and a fluid supply (3) for one or more fluids. The outlet fitting (2) is mounted close to the sink (45), e.g., at the edge (46) of the sink or on a bracket, and the fluids are let out in the direction of the sink (45).

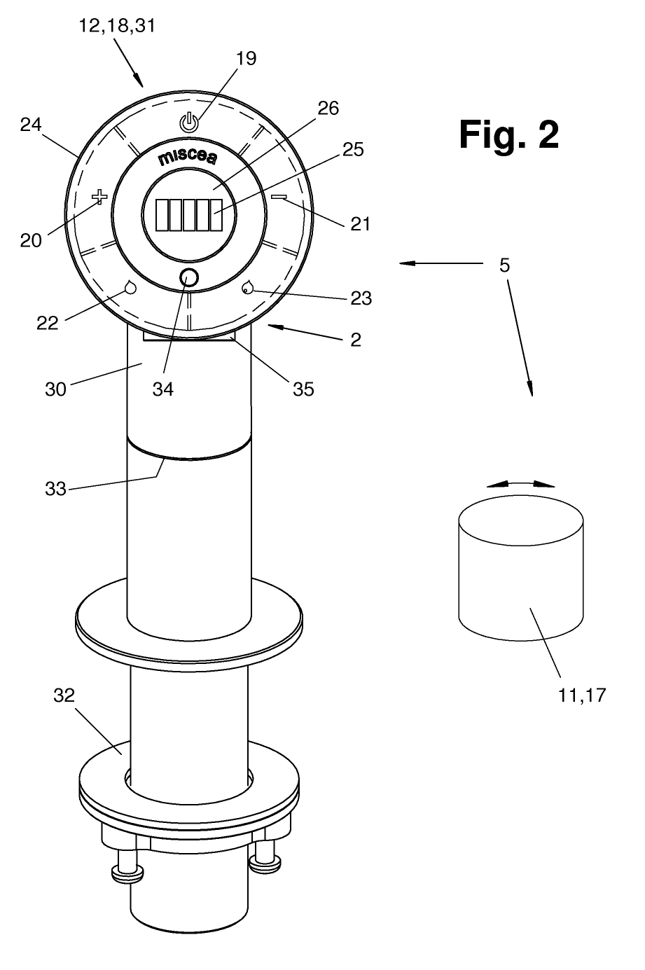

FIGS. 1 through 4, 5 and 6 show two variants of the kitchen fitting (1).

In both variants, the outlet fitting (2) has a fitting pipe (30), which preferably has a bent shape and is fastened at the lower or rear end to the edge of the sink or to a bracket with a fitting foot (32). A fitting head (31), which may receive a sensor unit (12) and a display unit (18), may be located at the upper, free end of the fitting pipe. The fitting pipe (30) may be rigid or movable, especially pivotable. It may have for this purpose a hinge (33) in the lower area, which is designed, e.g., as a pivot bearing. A grip (34), e.g., in the form of a frontally projecting pin or the like, with which the fitting pipe (30) can be pivoted, may be arranged on the fitting head (31). One or more outlet openings (35) for a respective fluid I, II, III are located at the upper area of the fitting pipe (30). The aforementioned design of the outlet fitting (2) may be the same in both variants, and the grip (34) may optionally also be absent or have another design and be arranged in a different manner.

The kitchen fitting (1) has an operating unit (5) with a control device (6) and with one or more operating elements (7 through 11), which are connected to the control device (6). At least some of the operating elements (7 through 10) can be actuated in a contactless manner and have at least one sensor (13, 14) each for this. A plurality of these sensors (13, 14) may be combined to form said sensor unit (12). The operating unit (5) may also have one or more operating elements (11) that are to be actuated by touch. The operation may take place in both cases with a part of the human body, especially a hand.

The control device (6) may be arranged in the embodiment shown in FIGS. 1 and 4 in a separate housing separately from the outlet fitting (2) and placed, e.g., under the bracket (46). The control device (6) or a part of it, e.g., a control circuit board (40), may also be arranged on the fitting head (31) in the manner to be explained below. The control device (6) has a computer with one or more microprocessors or microcontrol devices, memories for data and programs and interfaces for inputting and outputting data. In particular, one or more control programs may be stored in the control device (6).

The fluid supply (3) is connected to the outlet fitting (2) via one or more fluid lines (36) and dispenses one or more fluids I, II, III. The dispensing takes place in one or more fluid flows (47). At least one fluid I is water. One or two additional fluids II, III, e.g., a dishwashing detergent, a disinfectant, a skin care lotion or the like, can be dispensed via a plurality of outlet openings (35) in the embodiments being shown. The state of the fluid or fluids I, II, III may optionally be changed. Such a change may be, e.g., a temperature regulation of a fluid I, especially water. As an alternative or in addition, the intensity or flow rate of a fluid flow (47), especially a water flow, may also be set and optionally regulated.

An operating element (7) switches on a fluid flow (47) on actuation and switches it off again on repeated actuation. The fluid flow (47) can remain switched on after switching on independently from the time during which a body part is in the range of action (15) of the operating element (76). The operating element (7) is designed, e.g., as an on/off switch that can be actuated in a contactless manner for a fluid flow I, especially for water.

The contactless on/off switch (7) is connected to the control device (6) in a suitable manner via a line or via a wireless communication and switches on the fluid flow (47) by means of the control device (6) when actuated and switches it off when actuated again. An on/off switch (7) may be designed as a pulse switch, which sends a switching pulse to the control device (6) when actuated, and said control device connects a corresponding fluid valve (37), e.g., a solenoid valve, in a fluid line (36).

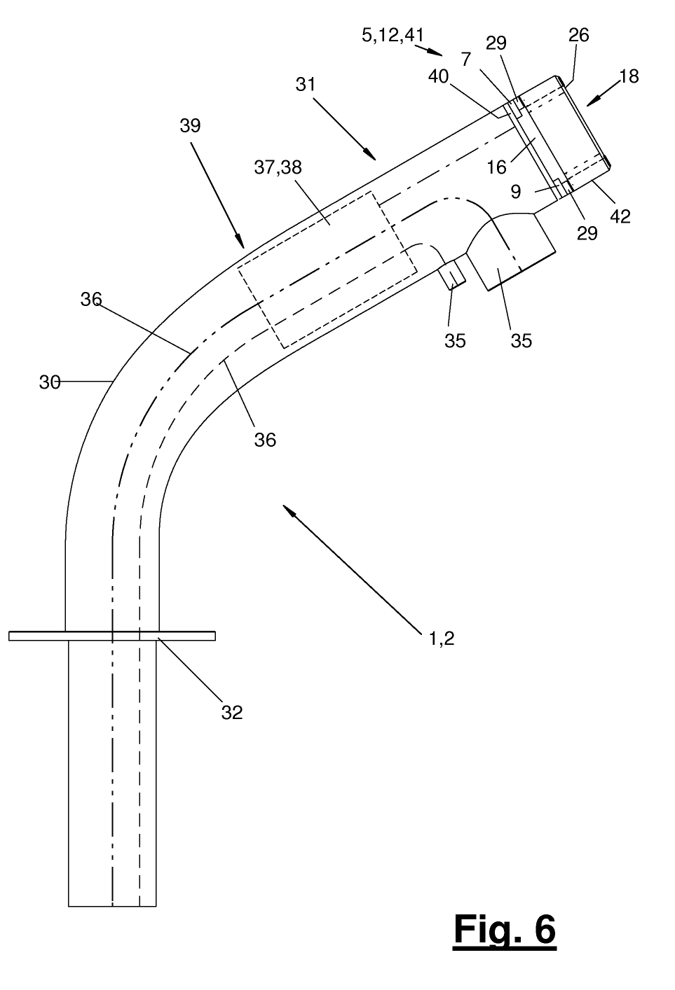

The fluid valve (37) may be arranged in any desired and suitable location. A possibility of installation in the fitting pipe (30), especially in the upper area thereof provided with a conical expansion (39), is shown in the second variant. The fluid valve (37) may be optionally connected to a distributor (38) for connecting a plurality of fluid lines (36) and for distributing and leading them to the outlet openings (35). The unit (37, 38) shown in FIG. 6 can be inserted from the upper, open pipe end and mounted in the fitting pipe (30).

The fluid valve (37) acted on by the contactless on/off switch (7) and the control device (6) has a blocking and opening function for the flow of fluid. It may be limited hereto and designed as a shut-off valve. If a flow rate control device is present, the aforementioned fluid valve (37) may be designed and adapted correspondingly for this. As an alternative, an additional control valve may be arranged in the fluid line (36) in question.

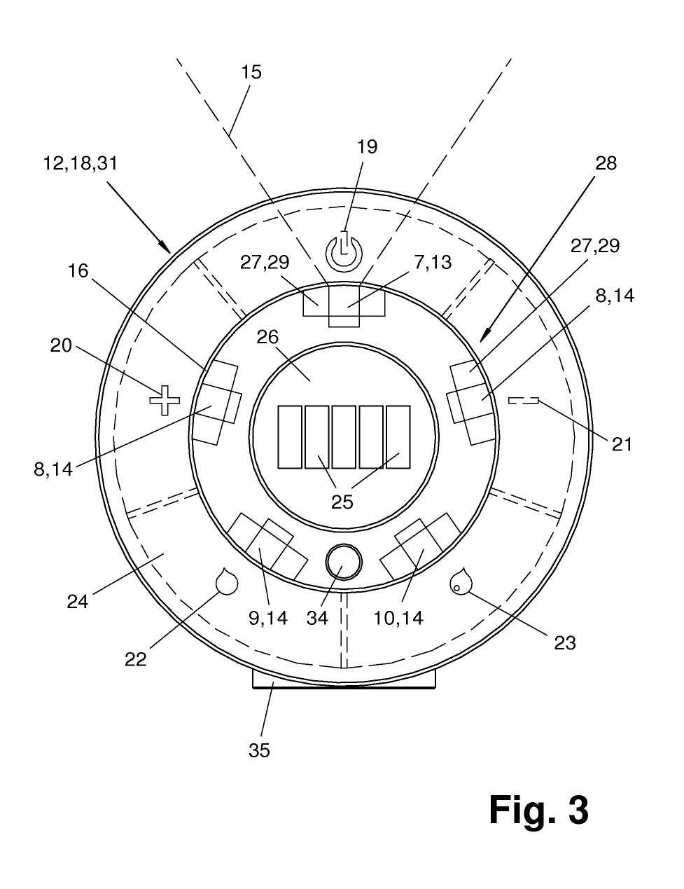

The operating element (7), especially the contactless on/off switch, has an upwardly directed range of action (15) in the embodiment being shown here, which is indicated by a broken line in FIG. 3. The on/off switch (7) can be actuated by a body part of the human operator in a contactless manner. As an alternative, the on/off switch (7) may have a range of action (15) directed to the side, especially forward, towards the human operator.

The contactless on/off switch (7) may have any desired and suitable design in order to detect a body part present in the range of action. In the embodiment shown, it has an optical sensor (13), which is designed as a reflected light scanner and operates preferably in the invisible range of light, especially in the infrared range. The reflected light scanner emits a light beam via a sensor part in the range of action (15), this beam is reflected from the body part when it falls on same and is received by a sensor part. The receiver signals are analyzed in the control device (6) and are recognized and used when a body part is recognized as a triggering or actuating signal.

The optical sensor (13) may have an outer cover (16), which is shown in FIGS. 3, 5 and 6 and which lets through the reflected light of the sensor (13) and reduces or blocks the incidence of outside light. The cover (16) may also be present for other contactless operating elements (8, 9, 10) and designed as a ring. It may have a filtering material, e.g., a plastic material, which is partially or completely nontransparent for light beams in the visible range.

The control device (6) has a program, which analyzes the sensor signals and makes a distinction between the senor light and the signal light, on the one hand, and stray light, on the other hand Due to the upwardly directed range of action (15) and the arrangement of the outlet fitting (2) in the usually well-lit kitchen area, the incidence of outside and stray light is relatively large and is usually stronger than in other arrangements and orientations of a sensor.

The contactless on/off switch (7) is arranged on the fitting pipe (30) in both variants shown. It is preferably located on the fitting head (31) arranged at the free upper end of the fitting pipe (30), The contactless on/off switch (7) may be part of the sensor device (12) mentioned in the introduction.

The operating unit (5) may have one or more additional contactless operating elements (8, 9, 10) for affecting one or more fluids I, II, III. In the first variant shown in FIGS. 1 through 4, three additional contactless operating elements (8, 9, 10) are present. The contactless operating elements (7, 8, 9, 10) have ranges of action (15) directed in different directions and may be designed, e.g., as temperature-setters and/or as selector switches for one or more additional fluids II, III. The operating elements (8, 9, 10) likewise have a sensor (14) of the above-described type, especially a reflected light scanner in the infrared range.

Two sensors (14) with lateral and opposite ranges of action, which are used as temperature-setters (8) for increasing or decreasing the temperature of a fluid, preferably water, are present to the left and right of the upper sensor (13) according to FIG. 3 in the first variant. Two additional operating elements (9, 10) and sensors (14) are present in the lower area of the sensor unit (12) for selecting two additional fluids II, III of the above-mentioned type.

The sensor unit (12) thus has, e.g., five sensors (13, 14) distributed uniformly on the jacket, which is, e.g., round, of the fitting head (31) in the first variant. The number and arrangement of the operating elements (8, 9, 10) and of the sensors (14) thereof may be changed in another embodiment.

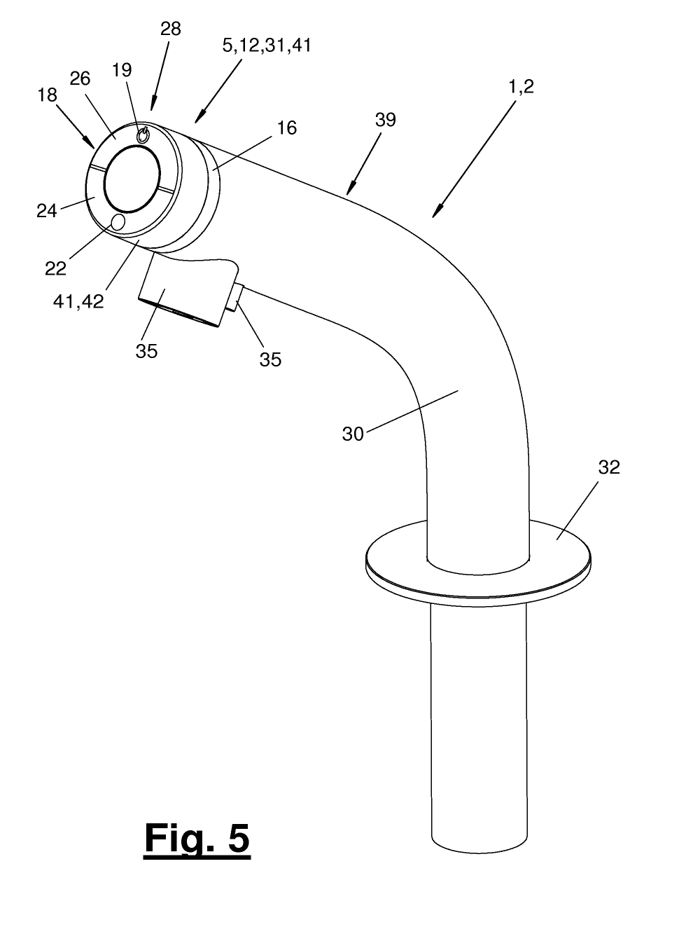

For example, only two contactless operating elements (7, 9), which are arranged diametrically to the central axis of the fitting pipe (30) or the fitting head (31) and are directed in opposite directions, are present in the second variant according to FIGS. 5 and 6. These may be, on the one hand, a contactless on/off switch (7) and a selector switch (9) for an additional fluid II, e.g., a dishwashing detergent. A temperature-setter is absent in this embodiment, and the temperature of the fluid, especially water, may be eliminated or achieved in another manner.

Other desired combinations of the contactless operating elements (7 through 10) may be present in other variants, not shown, and, e.g., only the contactless on/off switch (7) or a combination of this switch (7) with one or two selector switches (9, 10) for one or two additional fluids (II, III) is present. Such combinations may be quipped with or without temperature-setter (8). Furthermore, it is possible to combine the contactless on/off switch (7) with a temperature-setter (8) only. The display unit (18) is correspondingly adapted to the above-mentioned alternative combinations.

The operating unit (5) has, besides, a display unit (18) with one or more display elements (19-27), which are associated especially with the one or more operating elements (7-10). The two variants show different embodiments for the design and arrangement of the display unit (18). The display unit (18) may also be correspondingly adapted to the other above-mentioned variants and combinations of operating elements (7 through 10).

In the different exemplary embodiments, a display element (19) for a contactless on/off switch (7) displays the position and function of said switch. It may be associated with the corresponding switch (7) or sensor (13) in terms of the position in space and may be located especially at the range of action (15). To illustrate the function of the switch, the display element (19) may have a corresponding symbol, e.g., the interrupted circle shown with the dash arranged in the interruption.

The one or more additional contactless operating elements (8, 9, 10) that may be present may have corresponding display elements (20, 21, 22, 23), which are designed, e.g., in the first variant according to FIG. 3, as “+” and “−” signs and as, e.g., drop-shaped fluid symbols.

In the first variant, the display elements (19-23) are arranged on a common display carrier (24), which is designed, e.g., as a radially directed ring disk arranged in front on the fitting head (31), which consists, e.g., of a transparent material. The display elements (19-23) may be, e.g., lettering on the ring disk. The other display elements (20-23) are likewise associated with the respective operating elements (8, 9, 10) and signal the position and function thereof.

The display unit (18) may have additional display elements (25, 27), which signal set values and/or acknowledgment signals. When a temperature-setter (8) is present, e.g., a display element (25) may optically and/or acoustically signal the set temperature value. It may display the value, e.g., as a number or with one or more block symbols, e.g., illuminated color strips. The display element (25) may be formed for this, according to FIG. 3, e.g., by a row of LEDs, which display a color change from blue to red. The display element (35) may be arranged on a suitable display carrier (26). This may be, e.g., a display or the like on the front side of the fitting head (31). The display carriers (24, 26) may be arranged concentrically.

One or more additional display elements (27) may signal an acknowledgment for the successful actuation of the sensors (13, 14). This may likewise take place optically and/or acoustically. The display unit (18) may have, e.g., an illumination (28) with a plurality of lighting elements (29), which are each associated with the sensors (13, 14) and light up on successful triggering or command input and also illuminate and make visible or highlight the corresponding display element (19-23). The lighting elements (29) are arranged in the vicinity of the sensors (13, 14) and may be designed, e.g., as LEDs. The display unit (18) may have, in addition, a general illumination (28), which may serve decorative or other purposes and which may be formed by said lighting elements (29) and/or other lighting elements.

In another embodiment, the display elements (19-23) may be luminescent and may be formed, e.g., by an LED matrix or the like. In addition, they may be variable and display variable meaning contents.

The sensor unit (12) and the display unit (18) are arranged together on the fitting head (31), and the display carriers (24, 26) may be arranged in a protected manner in front of the contactless operating elements (7-10) in the direction of the pipe. The operating elements (7-10) and the sensors (13, 14) may be arranged, e.g., on a common control circuit board (40), on which the lighting elements (29) are arranged as well. This arrangement may be tightly and protectingly surrounded by a common housing (42) and the cover (16). FIG. 6 shows this arrangement as an example, which may also be used in the first variant.

The display elements (19, 22) for the on/off switch (7) and for the selector switch (9) are arranged on the front side of a transparent housing (42) illuminated from the rear in the second variant. This front side forms the display carrier (24). The display carrier (26) present in the first variant and a display element (25) for the temperature value or the like are, e.g., eliminated in the second variant.

In both variants, the operating unit (5) may have as an additional operating element (11) a flow rate setter for setting the intensity or flow rate of the fluid flow (47) switched by the contactless on/off switch. The flow rate setter (11) is arranged, e.g., separately from the contactless on/off switch (7) and may be located next to the fitting pipe (30) on the bracket (46). The flow rate setter (11) may optionally be connected to an additional display element of its own (not shown) or to a correspondingly adapted display device (18).

At least said two operating elements or switches (7, 11) are present in a preferred embodiment. One or more additional operating elements (8-10) may optionally be additionally present.

The flow rate setter (11) may likewise be able to be actuated in a contactless manner. It is designed as a manual setter that can be actuated by contact, e.g., as a knob, slide or the like, in the embodiment shown. The flow rate setter (11) is connected to a mechanically controllable or remote-controllable fluid valve, especially a control valve. This may be the fluid valve (37), which is present and was mentioned in the introduction, or an additional fluid valve.

A separate fluid valve is set purely mechanically and by the flow rate setter (11) only in a simple mechanical variant. In another embodiment, the fluid valve may be remotely controllable, and the flow rate setter (11) has an overrun function. The control valve may now have an additional drive, e.g., an electric drive connected to the control device (6). A preprogrammed jet intensity or flow rate, which becomes active on actuation of the on/off switch (7), can be preset hereby. This presetting may be changed with the manual setter (17), and this change is preferably active only during the time the fluid flow (47) in question is flowing.

The fluid supply (3) shown in FIGS. 1 and 4 may have any desired and suitable design. It is connected to a feed line for cold water or to a double line for cold and hot water. It may have, furthermore, one or more fluid containers (43) for said one or more additional fluids II, III. The fluid containers (43) may be replaceable and designed, e.g., as bags. They may be connected to the delivery unit (44) in a fluid-tight manner via corresponding ports at the outlet point. The fluid supply (3) may be designed, e.g., according to WO 2008/077619 A.

Various modifications of the embodiments shown and described are possible. The features of the above-described exemplary embodiments may be combined with one another in any desired manner and optionally replaced with one another.

The additional operating elements (8 through 11) may be present in any desired number and combination or may even be absent. They may also be arranged at other locations of the kitchen fitting (1), especially the outlet fitting (2). The flow rate setter (11) may likewise be designed as an operating element that can be actuated in a contactless manner. It may also be integrated in the sensor unit (12). Furthermore, the kitchen and multifunctional fitting (1) may have auxiliary devices (not shown), e.g., a reader, a management program or the like. This design may be like that in DE 10 2006 062 182 A1.

While specific embodiments of the invention have been shown and described in detail to illustrate the application of the principles of the invention, it will be understood that the invention may be embodied otherwise without departing from such principles.

1. A kitchen fitting comprising:
an outlet fitting;
a fluid supply for one or more fluids; and
an operating unit comprising a control device and one or more operating elements connected thereto, wherein one of the one or more operating elements is designed as a contactless on/off switch for a fluid flow wherein the contactless on/off switch switches on the fluid flow when actuated and switches the fluid flow off again when actuated again.

2. A kitchen fitting in accordance with claim 1, wherein the contactless on/off switch is designed as a pulse switch.

3. A kitchen fitting in accordance with claim 1, wherein the contactless on/off switch switches on the fluid flow when actuated by means of the control device and switches the fluid flow off again when actuated again.

4. A kitchen fitting in accordance with claim 1, wherein the contactless on/off switch has at least one of an upwardly directed range of action and a sideways directed range of action.

5. A kitchen fitting in accordance with claim 1, wherein the contactless on/off switch is designed as a sensor that can be actuated manually and in a contactless manner.

6. A kitchen fitting in accordance with claim 1, wherein the contactless on/off switch is designed as an optical sensor comprising an infrared reflected light scanner.

7. A kitchen fitting in accordance with claim 1, wherein the optical sensor has a cover reducing the incidence of outside light.

8. A kitchen fitting in accordance with claim 1, wherein the control device has a program for distinguishing sensor light and stray light.

9. A kitchen fitting in accordance with claim 1, wherein the contactless on/off switch is connected to a remotely controllable fluid valve comprising a shut-off valve, by means of the control device.

10. A kitchen fitting in accordance with claim 1, wherein the outlet fitting comprises a fitting pipe and the contactless on/off switch is arranged on a fitting head at the free upper end of the fitting pipe.

11. A kitchen fitting in accordance with claim 1, wherein the operating unit further comprises one or more additional contactless operating elements for affecting one or more fluids.

12. A kitchen fitting in accordance with claim 11, wherein the one or more additional contactless operating elements comprise at least one of temperature setters and selector switches for an additional fluid.

13. A kitchen fitting in accordance with claim 11, wherein the outlet fitting comprises a fitting pipe and the contactless on/off switch and the one or more additional contactless operating elements are integrated into a sensor unit and are arranged together on a fitting head at the free upper end of the fitting pipe.

14. A kitchen fitting in accordance with claim 1, wherein the contactless on/off switch and the one or more additional contactless operating elements have ranges of action directed in different directions, wherein the contactless on/off switch has an upwardly directed range of action.

15. A kitchen fitting in accordance with claim 1, wherein the operating unit has a display unit with a display element for the contactless on/off switch.

16. A kitchen fitting in accordance with claim 1, further comprising a display element for the contactless on/off switch wherein the display element displays the position and function of said on/off switch.

17. A kitchen fitting in accordance with claim 1, further comprising a display element that sends an acknowledgment signal for the performed actuation of the contactless on/off switch.

18. A kitchen fitting in accordance with claim 1, wherein the display unit has additional display elements for the one or more additional contactless operating elements.

19. A kitchen with fitting in accordance with claim 10, further comprising a display unit and a control circuit board, wherein the sensor unit and the display unit as well as the control circuit board are arranged together on a fitting head at the free upper end of the fitting pipe.

20. A kitchen fitting in accordance with claim 19, wherein an additional operating element is designed as a flow rate setter for setting the intensity of the fluid flow switched by the contactless on/off switch.

21. A kitchen fitting in accordance with claim 20, wherein the flow rate setter is arranged separately from the contactless on/off switch, especially next to the fitting pipe.

22. A kitchen fitting in accordance with claim 1, wherein the flow rate setter has a manual setter; knob.

23. A kitchen fitting in accordance with claim 1, wherein that the flow rate setter is connected to a mechanically controllable or remotely controllable valve control valve.

24. A kitchen fitting in accordance with claim 10, wherein the fitting pipe pivotable, and has a pivot bearing.

25. A kitchen fitting in accordance with claim 24, wherein the movable fitting pipe has a grip (34).

26. A kitchen fitting in accordance with claim 10, wherein at least one of a fluid valve and a distributor for a plurality of fluids are arranged in a conical expansion of the fitting pipe.

27. A kitchen fitting in accordance with claim 1, wherein the fluid supply has a delivery unit with one or more fluid lines and with one or more replaceable fluid containers for additional fluids, comprising at least one of detergents, disinfectants and skin care lotions.

28. A kitchen device comprising:
a kitchen sink; and
a kitchen fitting arranged at a sink edge, the kitchen fitting comprising an outlet fitting and a fluid supply for one or more fluids as well as an operating unit comprising a control device and one or more operating elements connected thereto, wherein the one or more operating elements is designed as a contactless on/off switch for a fluid flow wherein the contactless on/off switch switches on the fluid flow when actuated and switches the fluid flow off again when actuated again.

29. A method for operating a kitchen fitting, which has an outlet fitting and a fluid supply for one or more fluids as well as an operating unit with a control device and one or more operating elements connected thereto, the method comprising the steps of:
switching on a dispensing of the fluid flow from the outlet fitting by means of an operating element designed as a contactless on/off switch when actuated; and
switching off the dispensing of the fluid flow when actuated again.

30. A method in accordance with claim 29, wherein the contactless on/off switch is actuated by a motion of a body in it's a contactless on/off switch range of action.

31. A method in accordance with claim 29, wherein the fluid flow remains switched on after switching on independently from the duration of the time during which the body part is present in the range of action of the contactless on/off switch.
